(19) United States
(12) Patent Application Publication
(10) Pub. No.: US 2005/0183894 A1
(43) Pub. Date: Aug. 25, 2005

(54) Weighing system, method, and apparatus

(76) Inventor: Jean-Pierre Lair, San Antonio, TX (US)

Correspondence Address: THOMPSON & KNIGHT LLP, Suite 1700, 1700 Pacific Avenue, Dallas, TX, 75201-4693, US

(21) Appl. No.: 11/060,449

(22) Filed: Feb. 17, 2005

Related U.S. Application Data
(60) Provisional application No. 60/547,312, filed on Feb. 24, 2004.

(51) Int. Cl. G01G 23/38; G01G 19/40; A63B 21/08

(52) U.S. Cl. 177/3; 177/25.15

(57) ABSTRACT

A method, apparatus, and system of weighing a subject are disclosed. The inventive method, apparatus, and system includes use of at least two independent scales and may be particularly useful for facilitating the detection of misalignment of the human body. The method, apparatus, and system of this invention may provide the body weight that is supported by his left hip, leg, foot and associated joints, and the body weight that is supported by his right hip, leg, foot and associated joints. The method, apparatus, and system of this invention may also optionally provide the total weight of the body.

### PRIORITY INFORMATION

This application claims priority to U.S. Provisional Patent Application Ser. No. 60/547,312, filed Feb. 24, 2004, entitled “Weighing System, Method And Apparatus”. The content of that application is incorporated herein in its entirety by reference.

### FIELD

The present invention relates generally to a weighing system, method, and apparatus.

### BACKGROUND

Scales are known in the art. Scales used by people in their homes are commonly called “bathroom scales.” Scales used in the medical community generally differ from household bathroom scales by their better accuracy and higher price. However, bathroom scales or medical scales only provide the total weight of the person standing thereon. Prior art scales have no capability of measuring and indicating the supported weight distribution of the person between his left and right hip, leg, foot and associated joints. Therefore, these prior art scales have no ability of detecting body alignment or misalignment.

The musculo-skeletal functions are only retained through the regular use of all of the muscles. Specific muscles of the body are assigned specific tasks within the skeletal body design context. The muscle that is not regularly stimulated is put on hold to atrophy, and the function that this muscle is designed to fulfill is then taken-over by the peripheral muscle(s). The peripheral muscles act as substitute muscles to perform the function of the atrophied muscles, but since they are not designed to perform the particular function, they put the body out of alignment and over time their own design function becomes compromised. Therefore, the first dysfunction of atrophied muscle can lead to more dysfunction of the peripheral muscles.

As discussed above, the musculo-skeletal dysfunction causes body misalignment. Being aware of the body's design, and allowing it to work as intended can potentially reverse or prevent many of the disabling conditions that so often affect human beings. Once a body's dysfunction is displayed, the individual has the choice to undertake the necessary steps to correct the problem, as self-care is the earliest form of medical care.

### SUMMARY

Embodiments of the invention include a weighing system, method, and apparatus configured to bring awareness of body misalignment to a person. An inventive scale is disclosed which may be used by individuals in their homes, by the medical/therapeutic community and/or by athletic/sport facilities, etc. In an embodiment, the scale has the capability to measure and indicate to a person standing on it: 1) his body weight supported by his left hip, leg, foot and associated joints, and 2) his body weight supported by his right hip, leg, foot and associated joints. The scale may optionally indicate his total body weight.

In an embodiment of the invention, there is provided a method of weighing a person, the method including placing the person's left foot on a first scale; placing the person's right foot on a second scale; measuring a weight of the first scale's load; and measuring a weight of the second scale's load.

The scale in accordance with an embodiment of the present invention may be comprised of at least two independent weighing systems. The systems may be installed on a common base. The first system is the one that is measuring and indicating the body weight supported by the left hip, the left leg, the left foot and the associated joints. This first system may be of any type: totally mechanical, totally electronic, or even a combination of both. The second system is the system that is measuring and indicating the body weight supported by the right hip, the right leg, the right foot and the associated joints. Like the first system, the second system may be of any type. The first and second systems are independent and distinct in terms of weight measurement and indication. The third system is the one that is measuring and indicating the total weight. It is distinct from the two previous independent weight measurement systems, but its weight measurement and indication may be dependent on the two independent weight measurement systems. A third system may be used to indicate the total body weight, and can be of any type: mechanical, electronic, or a combination of both. The first, second and third systems may be housed in a common base.

The scale of the present invention, irrespective of the measuring and indicating systems that are used, is now capable of providing three weights: 1) the weight of the person supported by the left foot, left leg, left hip and associated joints, 2) the weight of the person supported by the right foot, right leg, right hip and associated joints, and 3) the total weight of the person that is derived from 1) and 2). Existing scales are not capable of providing to the person standing on them an unbalanced weight condition, if such condition exists.

The present invention allows discovery by an individual, and/or the medical/therapeutic community that he is consulting with, whether his body is misaligned, and whether he is experiencing musculo-skeletal dysfunction.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 depicts a block diagram of a system of scales in accordance with one embodiment of the invention; and

FIG. 2 depicts a diagram view of a scale in accordance with one embodiment of the invention.

### DETAILED DESCRIPTION

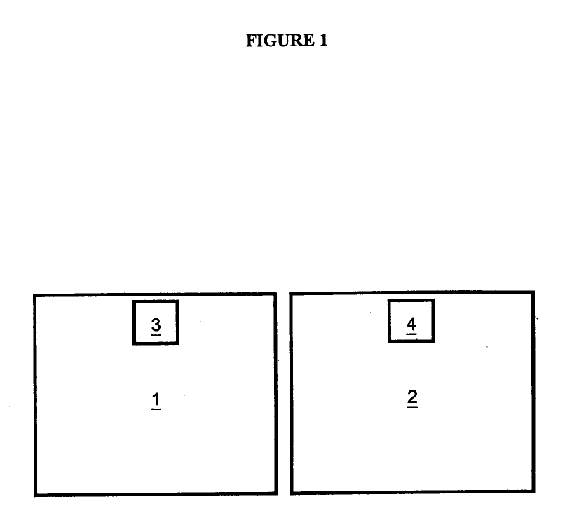

With reference to FIG. 1, a first scale 1 and a second scale 2 are shown. The first scale 1 and the second scale 2 are configured to operate independently of one another. The first scale 1 and the second scale 2 may be integrated into a single apparatus, or alternatively, they may be completely separate from each other. The first scale 1 may include a display 3 which shows the weight of the load on the first scale 1. Likewise, the second scale 2 may include a display 4 which shows the weight of the load on the second scale 2. The first scale 1 may include an audible indicator of the weight of the load on the first scale 1. For example, the weight of the load on the first scale 1 may be announced as “100 pounds.” Likewise, the second scale 2 may include an audible indicator of the weight of the load on the second scale 2.

In accordance with one embodiment of the present invention, a person may step on the first scale 1 with one foot, while stepping on the second scale 2 with the other foot. The weight of the load on the first scale 1 may be compared to the weight of the load on the second scale 2. If the weights are not equal, then it may be appreciated that the person's body lacks symmetry or alignment. The weight difference may be announced using an audible indicator in accordance with an embodiment of the invention. Such an audible indicator may be configured to announce the weight difference as well as the side of the body in which excess weight exists. Such non-symmetry or non-alignment may be indicative of a medical problem, including but not limited to musculo-skeletal dysfunction, muscular dystrophy, muscular atrophy, etc.

Thus, the present invention may be used to detect the misalignment of the human body for a person who is experiencing musculo-skeletal dysfunction and therefore who is already experiencing or will experience musculo-skeletal pain. The scale of this invention can be used on a preventive basis to help a person detect musculo-skeletal dysfunction by providing indication of his distributed weight between his left and right leg. Also, if a person is already experiencing musculo-skeletal dysfunction, causing pain or not, this invention allows the monitoring of his weight distribution.

The present invention also may be used in connection with aiding physical therapy. For example, the present invention may be used to evaluate and monitor the repair of a patient's atrophied muscle. The present invention may be used to monitor the patient's progress as the muscle is gradually repaired and restored to a healthy condition. Accordingly, the present invention may be used to determine whether a particular rehabilitation technique is or is not effective.

Referring again to FIG. 1, the weight of the load on the first scale 1 may be added to the weight of the load on the second scale 2 in order to determine a total body weight of the person. This method of weighing may be beneficial in situations, for example, in which the total body weight exceeds the maximum weight capacity of a single scale. It will be appreciated by those of skill in the art, however, that the subject being weighed need not be limited to a person, and that the apparatus, system, and method of the present invention may find application to non-human subjects.

In accordance with one embodiment of the present invention, an integrated scale may provide the total body weight of the person who is standing on it. A display (not shown) may show the person's total body weight. The measurement and indication of the body weight supported by the left hip, leg, foot and associated joints is independent of the measurement of the body weight supported by the right hip, leg, foot and associated joints. The measurement and indication of the total body weight is directly derived from the measurements of the weights supported by the left and right hip, foot, leg, foot and associated joints.

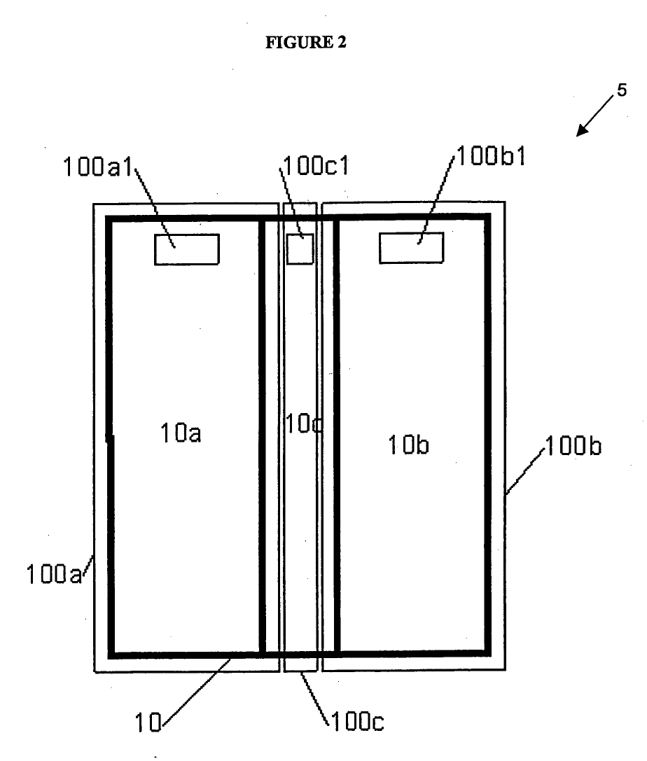

Turning to FIG. 2, a scale 5 is depicted in accordance with one embodiment of the invention which has a base 10 that may include independent zones 10a and 10b and may optionally include zone 10c. Zone 10a includes the left weight measuring and indicating systems, zone 10b includes the right measuring and indicating systems, and zone 10c includes the system that measures and indicates the sum of the weights information provided by zones 10a and 10b.

The sum of the individual weights measured by 10a and 10b may be displayed through a window 100c1 that may be provided in the cover 100c of the zone 10c. The measuring systems installed in each of the preceding zones may be of any type including but not limited to mechanical, electronic, or a combination. The indicating systems may be analog, digital, or a combination. The indicating systems may include visible indicators, audible indicators, or a combination. The system installed in zone 10a may adequately support a suitable cover 100a that represents the structure on which will rest the left foot of the person standing on it. The system installed in zone 10b may adequately support a suitable cover 100b that represents the structure on which will rest the right foot of the person standing on it. Each of the preceding covers may have a corresponding window 100a1 and 100b1 for display of the weight measured by the corresponding system.

When a person stands on the scale 5, the left foot rests on cover 100a, and the corresponding weight load is sensed, measured and displayed by the system that supports 100a and that is housed in zone 10a. Similarly, the right foot of the person rests on cover 100b, and the corresponding weight load is sensed, measured and displayed by the system that supports 100b and that is housed in zone 10b. The system that may be housed in optional zone 10c calculates the sum of the weights measured by the systems housed in zones 10a and 10b. The system in zone 10c may indicate the total sum of the weights by visible means, audible means, or both. In accordance with an alternative embodiment of the present invention, the scale 5 includes at least two independent zones (10a and 10b), but not 10c.

In accordance with other embodiments of the present invention, additional independent weight measuring systems may be included. Such embodiments may find use in connection with weighing objects (such as any objects desired to be symmetrical or properly aligned) having three or more feet.

The foregoing description is provided for illustrative purposes only and should not be construed as in any way limiting this invention, the scope of which is defined solely by the appended claims. Further modifications and alternative embodiments of this invention will be apparent to those skilled in the art in view of this description. Accordingly, this description is to be construed as illustrative only and is for the purpose of teaching those skilled in the art the manner of carrying out the invention. It is to be understood that the forms of the invention herein shown and described are to be taken as exemplary embodiments. Various changes may be made in the shape, size, and arrangement of parts. For example, it will be appreciated that equivalent elements or materials may be substituted for those illustrated and described herein, and certain features of the invention may be utilized independently of the use of other features.

1. A method of weighing a person, the method comprising:
placing the person's left foot on a first scale;
placing the person's right foot on a second scale;
measuring a weight of the first scale's load; and
measuring a weight of the second scale's load.

2. The method of claim 1, wherein the first and second scale are arranged on a common base.

3. The method of claim 1, wherein each of said first and second scales has a weight indicator.

4. The method of claim 3, wherein the weight indicator is digital.

5. The method of claim 1, further comprising:
comparing the weight of the first scale's load to the weight of the second scale's load.

6. The method of claim 1, further comprising:
determining the person's weight based on the weight of the first scale's load and the weight of the second scale's load.

7. The method of claim 6, wherein said determining comprises summing the weight of the first scale's load and the weight of the second scale's load.

8. The method of claim 1, further comprising announcing with an audible indicator the weight of the first scale's load and the weight of the second scale's load.
